(19) United States
(12) Patent Application Publication
(10) Pub. No.: US 2009/0007632 A1
(43) Pub. Date: Jan. 8, 2009

(54) EMPTY PIPE DETECTION

(75) Inventors: Thomas Will, Oberrotweil (DE); Martin Deutscher, Freiburg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: MIB GMBH MESSTECHNIK UND INDUSTRIEBERATUNG, Ihringen (DE)

(21) Appl. No.: 12/281,543

(22) PCT Filed: Jan. 31, 2007
(86) PCT No.: PCT/EP07/00810

§ 371 Date: Sep. 3, 2008

(30) Foreign Application Priority Data
Mar. 22, 2006 (DE) 102006012993.8

(51) Int. Cl. G01N 29/032

(52) U.S. Cl. 73/19.03

(57) ABSTRACT

A measuring apparatus (1) for detecting gases, in particular air, in a liquid-carrying transport line. The apparatus has at least one ultrasound transmitter (3) and at least one ultrasound receiver (4) as ultrasound sensors (3, 4), which are arranged essentially opposite one another with respect to a measuring pipe (2) in the region of the longitudinal sides of the measuring pipe (2), a control device (5) and a signal processing device (6). In order for the measuring apparatus (1) to operate with little disruption and to have a simple, cost-effective design, it is provided that the ultrasound transmitter (3) emits a continuous ultrasound signal, the signal processing device (6) amplifies the electrical signal processed by the ultrasound receiver (4), rectifies it, passes it to a memory device (6c) and uses a threshold value switch (9) to decide whether or not an electrical signal is then supplied to a control output and/or to a display device.

### BACKGROUND

The invention relates to a measurement apparatus for detecting gases, in particular, air, in a liquid-carrying transport line, with at least one ultrasonic transmitter and at least one ultrasonic receiver as ultrasonic sensors, which are arranged, with respect to a measurement pipe, essentially opposite each other in the region of the longitudinal sides of the measurement pipe, and with a control device and also a signal-processing device.

In industrial processes, for example, in manufacturing or also in food services, it is frequently necessary to detect whether a gas, in particular, air, is carried in a liquid line instead of or with the liquid to be transported. This can be necessary, among other things, to detect and prevent, first, in due time the corresponding line from drying off and optionally thus a pump connected to the line from running dry, and, second, also for the control of mixing processes or, for the transport of liquids for consumption, in order to control or prevent the carrying of foam.

In connection with this, various apparatuses for detecting the presence of gases in liquid-carrying transport lines have already been proposed. Here, first it involves apparatuses, in which a floating body that reacts to the presence of gases, is introduced into the relevant line. These apparatuses, however, can lack accuracy, in addition they are susceptible to contaminants that negatively affect their effectiveness and are also not optimal with respect to hygiene.

Already proposed apparatuses, which concern the optical detection of entrained gases in the liquid medium, make it necessary that the transport lines are transparent, or at least translucent. Moreover, residue of the medium deposited at certain positions of the line can lead to corruption of the measurement results.

Other measurement processes concern devices for measuring electrical resistance in the liquid medium, wherein the measurement electrodes necessary for this purpose have to be introduced into the transport line. Here, an electrically conductive medium must be used, the electrodes can corrode, and subsequently the medium can become contaminated. Moreover, the unambiguous detection of foam in the liquid cannot be guaranteed.

In addition, capacitive processes have also been proposed, in which, however, the measurement pipe or the transport line must be made from electrically insulating material. Here, if a plastic material is used, there is the risk that the liquid medium is absorbed by the material and then the material properties are changed, so that it is possible that gas in the medium can no longer be detected at all, or at least the settings of the measurement arrangement must be constantly adapted to the changed conditions.

Finally, for the detection of gas in the liquid-carrying transport lines, monitoring devices are also known, for example, from DE 31 41 576 A1 or EP 0 801 742 B1, which work on an ultrasonic basis, wherein the ultrasound energy is transmitted through the measurement pipe, and for the presence of gas or a large number of gas bubbles, the ultrasonic signal is subject to higher damping in the measurement pipe, wherein this signal attenuation is used in the evaluation. However, with a measurement or monitoring device, if only the comparatively simple decision is to be made whether a pipe is completely or at least partially empty, the known flow-rate measurement devices on an ultrasonic basis generate too large a measurement-specific overhead, which makes these devices unnecessarily complex in construction and can be expensive and impractical due to their equipment.

### SUMMARY

Therefore, the objective of the present invention is to make available a measurement device, which is easily constructed and which allows, with low costs, a detection of gas transport in the liquid-carrying line, as well as the decision on any possible alarm report and the flexible use of the device as a monitoring device.

This objective is met according to the invention in that the ultrasonic transmitter outputs a continuous ultrasonic signal, the signal-processing device amplifies the electrical signal processed by the ultrasonic receiver, rectifies it, leads it to a storage device, and, through the use of a threshold switch, decides whether an electrical signal is then fed to a control output and/or to a display device or not.

After generation of an ultrasonic signal on the ultrasonic transmitter, this signal is then emitted continuously transverse to the direction of extent of the measurement pipe and received by the ultrasonic receiver and converted into a form that can be processed by electronic components. Then amplification and rectification are performed and then the signal is led via an analog storage element to a threshold switch. As a function of its threshold setting, it is decided whether the applied signal is fed to a control output that triggers, in principle, any other process and/or to a display device, for example, an optical and/or acoustic display. According to the design of the measurement device, it can be an example that, in the case that the measurement pipe does not transport sufficient liquid or even becomes dry, that is, no liquid is transported, there is no signal on the threshold switch and this is the alarm-triggering criterion.

The apparatus according to the invention manages with a very simple signal-processing device in the form of electronic components due to the relatively simple decision it is to make, whether only the liquid medium itself or else a minimum value of a gas in the form of bubbles is transported in the liquid-carrying transport line. Therefore, the necessary installation space of the part of the measurement device responsible for the signal processing can be limited and the monitoring device can have a smaller design, due to lower space requirements, than conventional devices and can be easily placed and also, if necessary, even easily transported.

The measurement apparatus also has the already mentioned simple sensor arrangement, in which the ultrasonic sensors are arranged perpendicular to the flow direction of the transported medium, so that, different than in other known ultrasonic measurement devices, no flow and/or entraining effects have to be taken into account.

The equipment of the measurement apparatus with the mentioned threshold switch leads to the result that a high interference immunity of the measurement arrangement is achieved, because, for example, in the case of individual bubbles transported in the liquid, which are not necessarily negative or which do not have to lead to a system outage, an alarm does not necessarily have to be triggered. The behavior can be controlled by the adjustable threshold value.

Furthermore, with the measurement apparatus according to the invention, if necessary, long time periods can be continuously measured by the continuous charging of the measurement pipe with an ultrasonic signal, which makes the apparatus more preferable than other devices measuring using ultrasonic pulses, since, in the latter, losses occur in the detection time due to the conversion of the transmission direction for short pulses.

Finally, due to its low power consumption and waste power, the heat input into the medium to be measured can be limited, which is advantageous especially for a temperature-sensitive system.

One advantageous refinement of the measurement apparatus are provided in that this apparatus has a connection device with variable cross section, on which the ultrasonic sensors are arranged and in which a region of the transport line of variable nominal diameter forming the measurement pipe can be introduced and optionally fixed there. In this way, the measurement apparatus can also be arranged for any time limited demand at a desired position of a transport line and removed later after measurement took place. For fixing the transport line in a region between the ultrasonic sensors, here, for example, a pincers-like clamping mechanism could be used, which, itself could optionally be able to be fixed, fixes the transport line in a defined position relative to the ultrasonic sensors and the rest of the measurement apparatus.

In contrast, another embodiment of the measurement apparatus according to the invention provides that this apparatus is furnished with a separate measurement pipe, in the region of whose ends the ends of the transport line can be connected. In this case, the measurement pipe becomes a part of the transport line. Here, the measurement pipe is advantageously constructed as a straight, essentially rigid pipe piece, so that, relative to other systems, in which the measurement pipe made from more complicated channels is provided with arcs, kinks, and fixtures or the like, interference in the detection due to flow effects can be excluded. The measurement pipe represents a relatively short measurement section with its low transverse extent, which has, in turn, a positive effect on the overall smaller total dimensions of the measurement apparatus.

For protecting the components of the apparatus and for guaranteeing an undisturbed measurement procedure, in one refinement it can be provided that the measurement apparatus is housed together with the measurement pipe in a housing, which is provided, on its side, advantageously with connections for installation in a system structure, by which a simple integration in a liquid-carrying system is possible.

In order to provide even better protection of sensitive components of the measurement apparatus from environmental conditions, in a preferred embodiment of the measurement apparatus, the housing has a separate installation space for housing electronic components of the measurement apparatus or these components are located in a housing part that can be separated or that is separate.

In industry and food services, because frequently several transport lines of liquid media must be monitored simultaneously, a refinement of the measurement apparatus is provided in that this apparatus has devices for monitoring several transport lines. These can include, for example, several transport lines, which are each equipped with ultrasonic sensors, and are held in the housing. As a function of the equipment with control and signal processing devices, these several measurement channels can be operated and monitored alternately all together or else several or all simultaneously.

The ultrasonic transmitter and the ultrasonic receiver are ultrasonic sensors that are formed from a piezoelectric ceramic in one preferred embodiment of the measurement apparatus according to the invention. The control device also preferably comprises an oscillator, which excites the ultrasonic transmitter.

The storage device, to which the electrical signal is fed after its amplification and rectification, is constructed as an analog low-pass filter in one preferred embodiment of the measurement apparatus.

Because the material for the measurement pipe does not have to be transparent as, for example, in optical processes, the material selection is, in principle, subject to no restrictions. Preferably, however, the material of the measurement pipe can be formed from a plastic, for example, PE, PTFE, PFA, or the like, or a metal, for example, stainless steel, brass, copper, or the like.

To provide additional protection on one side of the measurement arrangement and to ensure good transmission of the ultrasonic signal between the ultrasonic sensors on the other side, preferably the measurement pipe and/or also other devices of the measurement apparatus can be formed, preferably, cast, in a solid material.

In order to generate a high sound level at low voltages, frequently relatively large ultrasonic converters in terms of their dimensions are used in comparison with the nominal diameter of the measurement pipe. Here it is possible that a part of the main lobe of the sound signal is discharged not through the measurement pipe, but instead through its walls, which leads to an interference signal. On the other hand, in principle, a feasible expansion of the measurement channel is rarely possible, if, for example, cross-sectional changes to the transport line are prohibited by legal regulations, for example, by laws concerning food. The occurring structure-borne sound then must be eliminated in some other way. For this purpose, in a preferred refinement of the measurement apparatus it can be provided that recesses, which are parallel to the measurement pipe and through which the sound is not propagated to the ultrasonic receiver, are formed in the solid material between the measurement pipe and the ultrasonic receiver. These recesses extend, in turn, as a channel and essentially parallel to the longitudinal extent of the measurement pipe. Its extent in the longitudinal direction here corresponds advantageously to at least that of the ultrasonic sensors.

The mentioned recesses, which are coaxial to the measurement pipe, are advantageously arranged in such a way that the distance between the recesses is smaller than the diameter of the measurement pipe. In this way, the recesses together with the measurement pipe form a triangular arrangement in cross section.

In an especially preferred way, the mentioned recesses are filled with a gas, in particular, air, which does not transport the sound further and through which sound occurring in the recesses is not let through to the ultrasonic receiver.

### BRIEF DESCRIPTION OF THE DRAWINGS

The measurement apparatus according to the invention will be explained in more detail below with reference to the figures in the drawing. Shown here in partially very schematized representation are:

FIG. 1 is a top view from above of a principle arrangement of a first embodiment of the measurement apparatus with ultrasonic sensors in the region of the measurement pipe,

FIG. 2 is a cross-sectional side view of another embodiment of the measurement apparatus with recesses arranged coaxial to the measurement pipe, and

FIG. 3 is a circuit diagram of the signal-processing device of the measurement apparatus.

### DETAILED DESCRIPTION OF THE PREFERRED EMBODIMENTS

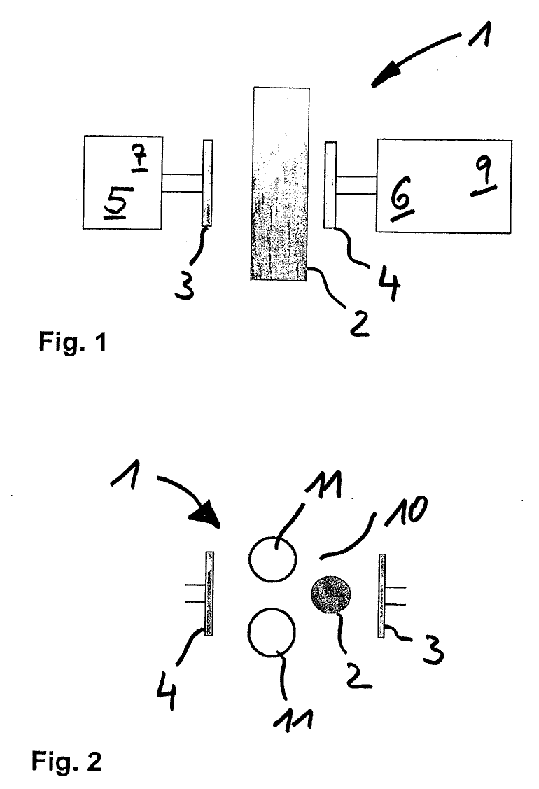

In FIG. 1, a measurement apparatus designated overall with 1 for the detection of gases, in particular, air, in a liquid-carrying transport line is to be seen. The measurement apparatus 1 has an ultrasonic transmitter 3 and an ultrasonic receiver 4 as ultrasonic sensors 3, 4, which are arranged with respect to the transport line forming the measurement pipe 2 essentially opposite each other in a region of the longitudinal sides of the measurement pipe 2, wherein the representation of additional, possibly necessary attachment elements has been eliminated. In addition, the measurement apparatus 1 is provided with a control device 5 and also a signal-processing device 6. Through excitation by an oscillator 7 not shown here, the ultrasonic transmitter 3 outputs, in the measurement operation, a continuous ultrasonic signal, which passes through the measurement pipe 2 and is received by the ultrasonic receiver 4 and is converted into an electrical signal proportional to the amplitude of the acoustic signal. By using the signal-processing device 6, the electrical signal processed by the ultrasonic receiver 4 is then amplified, rectified, and fed to a memory device 6c not shown in more detail. Then a similarly not visible threshold switch 9 decides whether an electrical signal is to be fed or not to a control output and/or to a display device. In the measurement pipe 2 that can be seen in FIG. 1, instead of to the transport line used here, it can be built by a separate measurement pipe 2, which is formed advantageously from a rigid pipe piece of defined diameter and which is formed between the free ends of the transport line and thus becomes a part of this line.

FIG. 2 shows another preferred embodiment of the measurement apparatus 1, in which additional measures are taken for preventing interference signals caused by structure-borne sound in the walls of the measurement pipe 2. For the sake of clarity, in this FIG. 2, only the ultrasonic sensors 3, 4 without the other devices 5, 6, 7, 8, 9 of the measurement apparatus 1 are shown. Together with the measurement pipe 2, the ultrasonic sensors are cast in a solid material 10 that is suitable for transmitting sound, wherein the ultrasonic transmitter 3 is attached as close as possible in a region of the measurement pipe 2, while the ultrasonic receiver 4 has a certain distance to the measurement pipe 2 for the reason explained below. When acting on the measurement pipe 2 with an ultrasonic signal by the ultrasonic transmitter 3, the sound signal passes through the measurement pipe 2 filled with the transported liquid medium and is forwarded by the solid material 10 in the direction of the ultrasonic receiver 4. In the solid material 10, between the measurement pipe 2 and the ultrasonic receiver 4 there are two recesses 11, which are coaxial to the measurement pipe 2 and which have a somewhat smaller distance from each other than the diameter of the measurement pipe 2 and which are filled with air. With the approximately triangular cross-sectional arrangement of the recesses 11 with the measurement pipe 2, structure-borne sound acting as an interference signal and preventing the desired measurement result is eliminated.

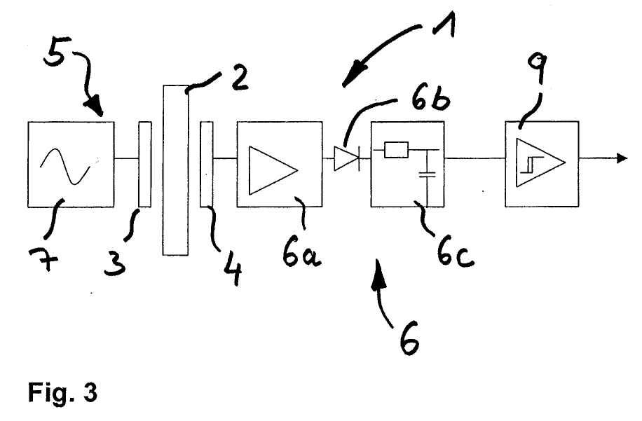

Finally, in FIG. 3 a block circuit diagram of the measurement apparatus 1 is shown, on which the signal path of the ultrasonic signal can be traced. Generated by an oscillator 7 allocated to a control device 5, the ultrasonic transmitter 3 of the measurement apparatus 1 arranged in the region of the longitudinal side of the measurement pipe 2 transmits a corresponding ultrasonic signal, which passes through the measurement pipe 2 and is received at the other longitudinal side of the measurement pipe by an ultrasonic receiver 4 arranged in this region, converted into an electrical signal, and forwarded to a signal-processing device designated overall with 6. Through the use of an amplifier 6a and a rectifier 6b, the electrical signal reaches a memory device 6c, which is constructed as an analog low-pass filter, and from there a threshold switch 9. As a function of its adjustable threshold value, the signal then optionally operates a not shown control output or a display device, which are in the position to react accordingly to an applied alarm or else to at least display this alarm.

Thus, the present invention relates to a measurement apparatus 1 for detecting gases, in particular, air, in a liquid-carrying transport line, with at least one ultrasonic transmitter 3 and at least one ultrasonic receiver 4 as ultrasonic sensors, which are arranged with respect to a measurement pipe 2 essentially opposite each other in the region of the longitudinal sides of the measurement pipe 2, and with a control device 5 and also a signal-processing device 6. The measurement apparatus 1 distinguishes itself in that the ultrasonic transmitter 3 outputs a continuous ultrasonic signal, the signal-processing device 6 amplifies the electrical signal processed by the ultrasonic receiver 4, rectifies it, forwards it to a storage device 6c, and, through the use of a threshold switch 9, decides whether an electrical signal is then to be fed or not to a control output and/or to a display device.

1. Measurement apparatus (1) for detecting gases in a liquid-carrying transport line, comprising at least one ultrasonic transmitter (3) and at least one ultrasonic receiver (4) as ultrasonic sensors (3, 4), which are arranged with respect to a measurement tube (2) essentially opposite each other in a region of longitudinal sides of the measurement tube (2), and a control device (5) and a signal-processing device (6), the ultrasonic transmitter (3) outputs a continuous ultrasonic signal, the signal-processing device (6) amplifies the electrical signal processed by the ultrasonic receiver (4), rectifies it, forwards it to a storage device (6c), and is adapted to determine, through the use of a threshold switch (9), whether to transmit an electrical signal to a control output and/or to a display device.

2. Measurement apparatus according to claim 1, further comprising a connection device with variable cross section, on which the ultrasonic sensors (3, 4) are arranged and in which a region of the transport line of variable nominal diameter forming the measurement tube (2) can be introduced and optionally fixed thereto.

3. Measurement apparatus according to claim 1, further comprising a separate measurement tube (2) on which the ultrasonic sensors are arranged, in a region of whose ends the ends of the transport line can be connected.

4. Measurement apparatus according to claim 3, further comprising a housing in which the measurement tube (2) is located along with other components of the apparatus, which on its part, is advantageously provided with connections for installation in a system structure.

5. Measurement apparatus according to claim 4, wherein the housing has a separate space for receiving electrical components of the measurement apparatus (1) or the electrical components are located in a housing part that can be separated or that is separate.

6. Measurement apparatus according to claim 1, wherein the measurement apparatus (1) includes devices for monitoring several transport lines.

7. Measurement apparatus according to claim 1, wherein the ultrasonic transmitter (3) and the ultrasonic receiver (4) are constructed from a piezoelectric ceramic.

8. Measurement apparatus according to claim 1, wherein the control device (5) comprises an oscillator (7), which excites the ultrasonic transmitter (3).

9. Measurement apparatus according to claim 1, wherein the storage device (6c) is constructed as an analog low-pass filter.

10. Measurement apparatus according to claim 1, wherein the measurement tube (2) is constructed from a plastic or from a metal.

11. Measurement apparatus according to claim 1, wherein the measurement tube (2) or additional devices (3, 4, 5, 6, 7, 8, 9) of the measurement apparatus (1) are formed in a solid material (10).

12. Measurement apparatus according to claim 11, wherein recesses (11) that are coaxial to the measurement tube (2) are formed in the solid material (10) between the measurement tube (2) and the ultrasonic receiver (4).

13. Measurement apparatus according to claim 12, wherein the distance between the recesses (11) is smaller than a diameter of the measurement tube (2).

14. Measurement apparatus according to claim 12, wherein the recesses (11) are filled with air.

15. Measurement apparatus according to claim 10, wherein the measurement tube is constructed from PE, PTFE or PFA.

16. Measurement apparatus according to claim 10, wherein the measurement tube is constructed from stainless steel brass or copper.
